(19) United States
(12) Patent Application Publication
(10) Pub. No.: US 2008/0133434 A1
(43) Pub. Date: Jun. 5, 2008

(54) Method and apparatus for predictive modeling & analysis for knowledge discovery

(76) Inventors: Adnan Asar, Livermore, CA (US); Ravi Mallela, Oakland, CA (US); Victor N. Pavlov, Palo Alto, CA (US); Sinclair Hamilton Hitchings, Palo Alto, CA (US)

Correspondence Address: Jonathan O. Owens;Havestock & Owens LLP, 162 North Wolfe Road, Sunnyvale, CA, 94086, US

(21) Appl. No.: 10/987,784

(22) Filed: Nov. 12, 2004

(51) Int. Cl. G06F 15/18

(52) U.S. Cl. 706/12

(57) ABSTRACT

A device and method designed to carry out the computation of a wide range of topological indices of molecular structure to produce molecular descriptors, representing important elements of the molecular structure information including but not limited to molecular structure variables such as; the molecular connectivity chi indices, ^{mX}ₜ, and ^{mX}ₜ^{v}; kappa shape indices, ^{mκ} and ^{mκα}; electrotopological state indices, Sᵢ; hydrogen electrotopological state indices, HESᵢ; atom type and bond type electrotopological state indices; new group type and bond type electrotopological state indices; topological equivalence indices and total topological index; several information indices, including the Shannon and the Bonchen Trinajstic information indices; counts of graph paths, atoms, atoms types, bond types; and others.

### RELATED APPLICATION(S)

This Patent Application claims priority under 35 U.S.C. § 119(e) of the co-pending, co-owned U.S. Provisional Patent Application Ser. No. 60/520,453, filed Nov. 13, 2003, and entitled “METHOD AND APPARATUS FOR IDENTIFICATION AND OPTIMIZATION OF BIOACTIVE COMPOUNDS.” The Provisional Patent Application Ser. No. 60/520,453, filed Nov. 13, 2003, and entitled “METHOD AND APPARATUS FOR IDENTIFICATION AND OPTIMIZATION OF BIOACTIVE COMPOUNDS” is also hereby incorporated by reference in its entirety.

### FIELD OF THE INVENTION

This invention relates to predictive modeling and analysis, and more particularly provides a process and a method to the prediction of chemical activity of molecules by utilizing specific machine learning techniques:

### BACKGROUND OF THE INVENTION

The problem of empirical data modeling is germane to many engineering applications. In empirical data modeling a process of induction is used to build up a model of the system, from which it is deduced responses of the system that have yet to be observed. By its observational nature data obtained is finite and sampled; typically this sampling is non-uniform and due to the high dimensional nature of the problem the data will form only a sparse distribution in the input space. Consequently the problem is nearly always ill posed.

Many general learning tasks, especially concept learning, may be regarded as function approximation. Examples of the function are given and the aim is to find a hypothesis (a function as well), that can be used for predicting the function values of yet unseen instances, e.g. to predict future events.

Performing predictive modeling and analysis has been filled with challenges. Robust techniques are required in order to build models that can make accurate predictions. The core challenges in predictive modeling and analysis resides in the following factors:
A High Dimensional Feature Space—Many times, the input space describing the components have high dimensionality, leading to “information overload” for model building.
Sparse Data—Many times, the input space that describes the components has sparse data, particularly for 2D fingerprints and 3D pharmacophores.
Few Positive Examples—Many times, the data set or one of the desired classes has a small number of inputs. ADME data in QSPR (Qualitative Structural-Property Relationship) predictive modeling and analysis often have small data sets and HTS data often have an active class of smaller than 1% of the total data set.
Large Number of Features/Features Sets With Unknown Impact—Relevant features have to be selected from a huge selection of potentially useful features. This makes it likely that at least some of the features that are in reality uncorrelated with the labels appear to be correlated due to noise.
Noise in the Ground Truth—If the model cannot effectively account for noise in the input and output, and then the accuracy of model will decrease in relationship to the amount and magnitude of the noise. Moreover, different testing datasets can have varying level of noise in the testing sets.
Model Over fitting—Models are developed based on training data that can lead to over fitting. A robust model must balance between fitting the training data well while, at the same time, being “general” enough to make accurate predictions on experimental or unknown data.
Different Distributions—In situations where the training set may cause from a very different distribution than the ultimate test set (e.g. if drawn from an earlier time period with substantial concept drift), or instead if the training set features are not predictive of the class variable, then choosing the best general method based on the training set will ultimately result in unpredictable testing performance. This can be viewed as a form of “overfitting” in that, if the chosen classifier matches the deformed testing distributing. This is a very real problem in real-world industrial settings.

The resulting challenges can lead to gross approximations in model building the lead to models that demonstrate degenerative results on test data. Accordingly, a need exists to optimize the prediction by employing a method that overcome the limitations discussed above such that the discovery of useful knowledge is made more accurate, rapid, efficient and interpretable.

### SUMMARY OF THE INVENTION

Briefly stated, the invention described herein provides a method and apparatus for predictive modeling & analysis for knowledge discovery by utilizing the following machine learning techniques:
Generating Molecular Descriptors and Fingerprints in case the problem is to identify and optimize bioactive compounds in QSPR analysis.
Selecting type of experiment—Classification and Regression or both
Data Import
Special Chunking for Unbalanced Datasets
Data Normalization and Data Cleaning
Dimensionality Reduction Prior to Model Generation
Chi-Squared algorithm for feature reduction
Modeling Building—Using Support Vector Machines
Grid Search
Auto Train Search
V-Fold Cross Validation
One-leave-Out Cross Validation
Sub-sampling Validation
Boosting
Bagging
Model Assessment, Model Selection and Error Analysis
Auto-threshold tuning for classification
ROC Graph
Confusion Matrix
Enrichment Curve
Dominant Feature Selection
Non-linear Feature Selection for Support Vector Machines
Linear Feature Selection for Support Vector Machine
Dimensionality Reduction Post Model Generation
Forward Selection and Backward Elimination
Zero-norm Backward Elimination
Correlation Discovery
Correlation Coefficient
Unbalanced Univariate Correlation
Multivariate Unbalanced Correlation
Cluster Analysis
Transductive Inference
Noise Discovery
Non-Linear Feature Selection for Non-Support Vector Algorithm
Incremental Learning

### BRIEF DESCRIPTION OF THE DRAWINGS

FIG. 1 illustrates the invention workflow.

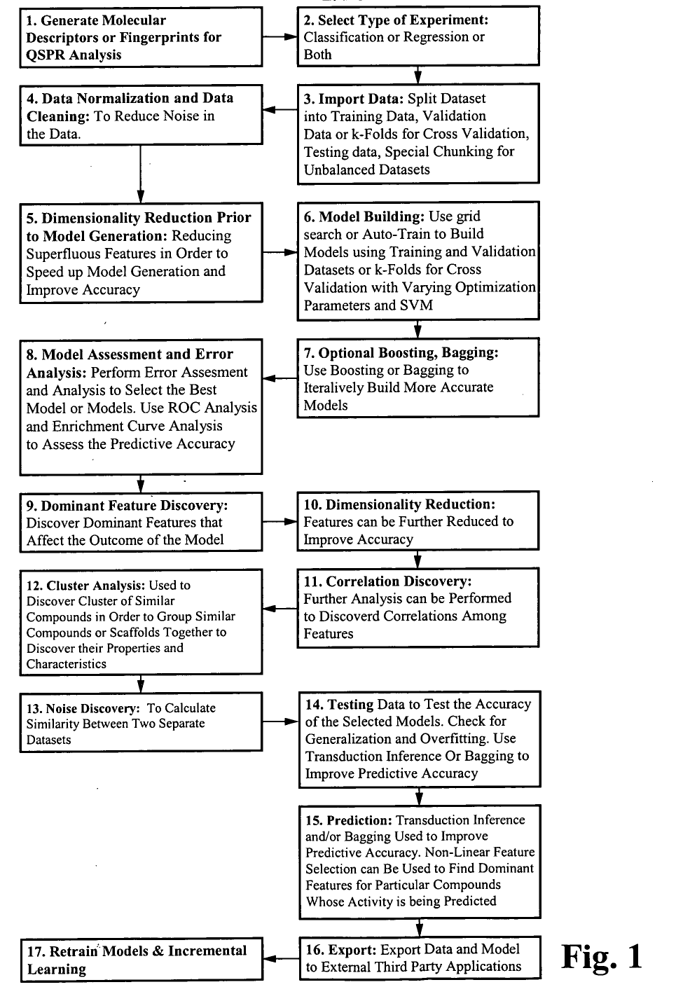

FIG. 2 illustrates molecular descriptors displayed in Equbits Foresight after being generated.

FIG. 3 illustrates exemplary linear classifiers.

FIG. 4 illustrates an Auto-Train run in Equbits Foresight.

FIG. 5 illustrates a search space in a fixed pattern about the current point.

FIG. 6 illustrates regressions results: RMS and R2.

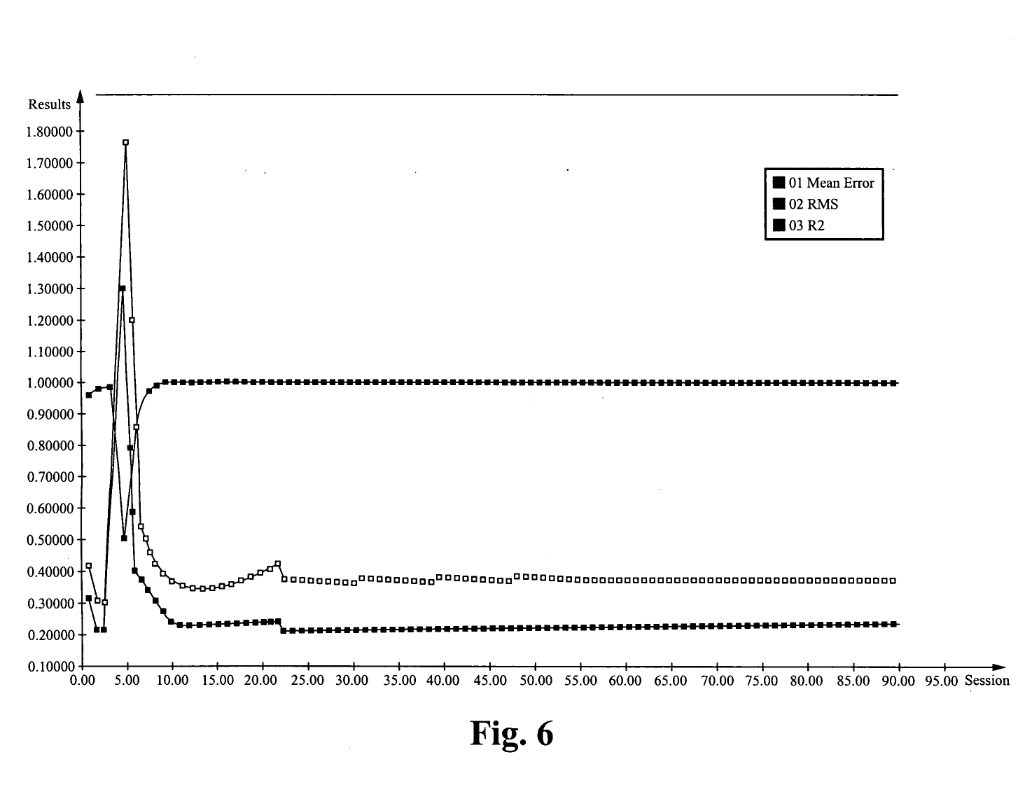

FIG. 7 illustrates a ROC Graph in Equbits Foresight.

FIG. 8 illustrates an enrichment curve in Equbits Foresight.

FIG. 9 illustrates Dominant Feature Ranking in Equbits Foresight.

FIG. 10 illustrates transductive interference.

### DETAILED DESCRIPTION OF THE PREFERRED EMBODIMENT

### 1. Generating Molecular Descriptors and Fingerprints

The software is designed to carry out the computation of a wide range of topological indices of molecular structure to produce molecular structure to produce molecular descriptors. These descriptors and indices represent important elements of the molecular structure information which is useful in relating structure to properties. These variables of molecular include (but are not limited to) the molecular connectivity chi indices, ^{mX}ₜ, and ^{mX}ₜ^{v}; kappa shape indices, ^{mκ} and ^{mκα}; electrotopological state indices, Sᵢ; hydrogen electrotopological state indices, HESᵢ; atom type and bond type electrotopological state indices; new group type and bond type electrotopological state indices; topological equivalence indices and total topological index; several information indices, including the Shannon and the Bonchen Trinajstic information indices; counts of graph paths, atoms, atoms types, bond types; and others.

Given molecular structure, the software is designed to produce elements known as structural keys, signatures, or molecular fingerprints (or, more simply, fingerprints) represent a set of features derived from the structure of a molecule. The particular features calculated from the structure can be quite arbitrary and depend on the topology of the chemical graph or even a 3D conformation. Different fingerprint schemes emphasize different molecular attributes according to the design philosophy of the fingerprint system. The fundamental idea is to encapsulate certain properties directly or indirectly in the fingerprint and then use the fingerprint as a surrogate for the chemical structure. Comparisons between molecules are then reduced to comparing sets of features and measuring the degree to which sets overlap.

As a simple example, consider a universe of features consisting of:

U={is-aromatic, has-ring, has-C, has-N, has-O, has-S, has-P, has-halogen}

Based on this definition of features, all molecules are described by subsets of U. Note that, in this small universe of 8 features, there are only 2⁸(256) possible fingerprints, which means that all chemical structures will be mapped to one of 256 possible subsets. In other words, there are only 256 possible “molecules.”

These fingerprints and molecular descriptors have been widely used in QSPR and QSAR analyses and other types of relationships between the structure of molecules and their properties. Input of molecular structure is done with molecular structure file formats including: Daylight SMILES, MDL (sdf), or Tripos (mol2).

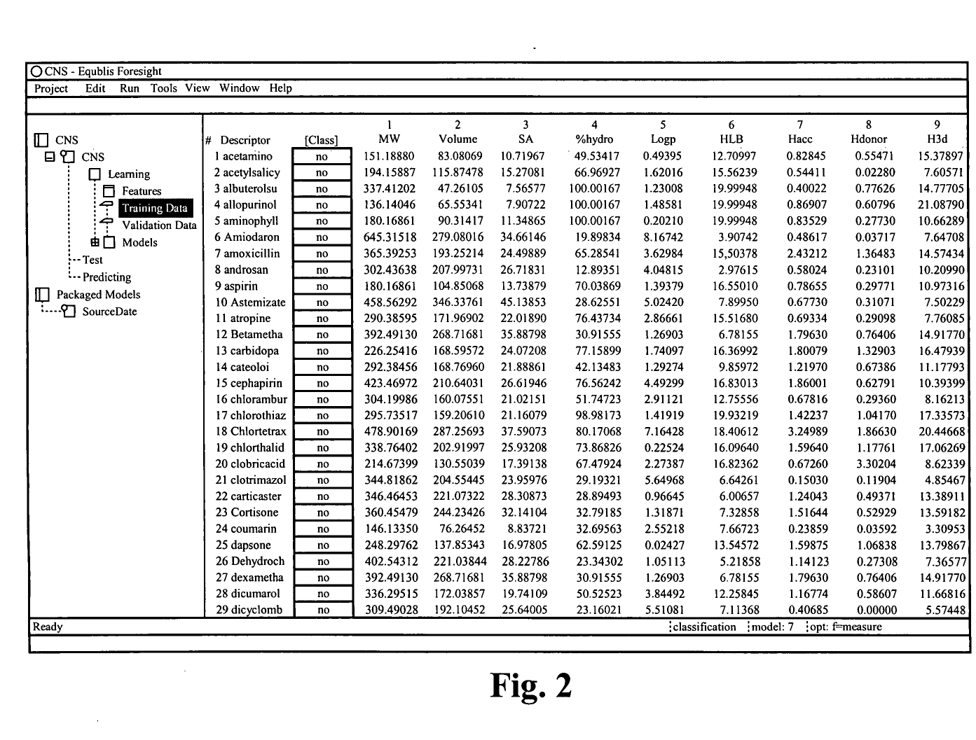

FIG. 2: Molecular Descriptors Displayed in Equbits Foresight after being Generated

### 2. Type of Experiment

Predictive analysis can be run for the following two types of experiments:
Classification
Regression
   2.1 Classification: Use classification models when you wish to compute predictions for a discrete or categorical dependent variable. Common examples of dependent variables in this type of model are binary variables in which there are exactly two levels (such as, the active and inactive compounds) and multinomial variables that have more than two levels (such as, disease types). The variables in the model that determine the predictions are called the independent variables. All other variables in the data set are simply information or identification variables.
   2.2 Regression: Use regression models when you wish to compute predictions for a continuous dependent variable. Common examples of dependent variables in this type of model are solubility, toxicity, income and bank balance. The variables in the model that determine the predictions are called the independent variables. All other variables in your data set are simply information or identification variables.

The Foresight software allows the user to select the type of modeling experiment that he or she wishes to perform.

### 3. Data Import

Equbits Foresight allows data to be imported for the learning and testing phases. Learning dataset consists of the training dataset and the validation dataset:

Training dataset: Data used for training the model during the learning phase in order to fit the model.

Validation dataset: Dataset used for validating the model during the learning phase and to estimate the prediction error for model selection.

Test dataset: Test data set used for testing a model after learning is done. This helps to determine how much over-fitting was achieved during the learning phase. Over fitting points to a model that is highly well trained for the data set used in the learning phase but performs poorly for data it has not encountered. Used for assessment of the generalization error of the final chosen model. Test data set should be only used at the end of the data analysis.

It is difficult to give a general rule on how to choose the number of observations in each of the three parts, as this depends on the signal-to-noise ratio in the data and the training sample size. A typical split might be 60% for training and 20% each for validation and testing.

### 3.1 Special Chunking for Unbalanced Datasets

For large unbalanced data sets where the number of in-actives is a lot more than actives, model building can be very time consuming. When one class is much higher percentage of the total data set than the other, a fraction of the dominant class can be taken thus making model building much faster.

Equbits Foresight support this approach for manual training, grid search and pattern search with and without v-fold cross validation. A rule of thumb is that 5× the number of the smaller class can be used. However, for very sparse data sets a larger multiplier should be used. This ratio is set to 5 by default but can be changed in the user interface by the user.

### 4. Data Normalization and Data Cleaning

4.1 Normalization: Normalization is used to scale all feature and class values to similar range such as 0 to 1. This assures that not any one feature is contributing more heavily to the model this making the model less accurate. There are two different algorithms that are allowed by Equbits Foresight:

0-1 normalization

$$F = \frac{O - {S}^{min}}{R}$$

where
F is the new feature value
O is the original value
S^{min} is the minimum value of the feature's range
R is the range value of the feature. R is calculated as R=S^{max}−S^{min}

The de-scaling is performed as:

Oᵢ=Fᵢ*Rᵢ−S^{min}ᵢ

### Unit Normalization

The feature's original value is normalized by dividing it by the Euclidean norm for the same feature set. The Euclidean norm is the square root of the sum of the squares of all values for a feature.

Fᵢ=Oᵢ/ENorm(F)

### Where

Fᵢ is the new feature value
Oᵢ is the original feature value
ENorm(F)=Euclidean norm of values of feature F=Square Root(Sum(Square(Fᵢ)))
   4.2 Data Cleaning: Most data, especially business data, is notoriously “dirty.” The following methodologies are provided by Equbits Foresight for cleaning your data:
Unnecessary Feature Elimination—Some features will have all the same values and not be useful for modeling. These should be dropped. Either all 1s or 0s can be dropped.
Missing Values—This functionality allows you to deal with your data's missing values in one of the five different ways. You can filter all rows containing missing values from your dataset attempt to generate sensible values for those that are missing based on the distributions of data in the columns, replace the missing values with the means of the corresponding columns, carry a previous observation forward, or replace the missing values with a constant you choose.
Outlier Detection—This functionality detects multidimensional outliers in your data. Based on the information returned by Outlier Detection, you may choose to filter certain rows that are flagged by the component as outliers.
   5. Dimensionality Reduction Prior to Model Generation¹ ¹Krzyzstof, Norbert Janowski. Complex Models for Classification of high-dimension data—exploration with Ghostminer

Biological and chemical molecular descriptors of compounds can have very high dimensionality especially when fingerprints are generated. Dimensionality reduction of features prior to model generation can be performed in order to reduce the number of superfluous features in order to improve the performance of generating fingerprints. Much of the feature reduction for fingerprints in Equbits Foresight is done by eliminating all fingerprints that don't appear at least n times (typically at least 2 or more times). Further reduction can be achieved in Equbits Foresight by algorithms such as chi-squared, chi-squared, t-test, pearsons coefficient.

Algorithm for chi-squared:

| | 0 | 1 |
|---|---|---|
| Active | A | B |
| In-Active | C | D |

A + B = AB
C + D = CD
A + C = AC
B + D = BD
A + B + C + D = n
(AB · AC)/n = A*
(AB · BD)/n = B*
(CD · AC)/n = C*
(CD · BD)/n = D*
([A − A*] \hat{ }2/A* + ([B − B*]\hat{ }2)/B* + ([C − C*]\hat{ }2)/C* + ([D − D*]\hat{ }2)/D*

### 6. Configuring Optimization Parameters

Equbits Foresight provides a user with the ability to select a parameter used for assessing and selecting models during grid search and auto train. These optimization parameters include:

Classification: F-Measure, Error Rate, Accuracy, Precision, Recall, Enrichment, Balanced Accuracy, Balanced Standard Error, Model Complexity, Top 1% Actives, ROC Area Under the Curve

Regression: Error Rate, RMS, R2, Mean Absolute Error, Mean Relative Error

Definitions of these terms are given below in section 7 (Model Assessment and Model Selection.)

### 6. Model Building

Support Vector Machine² ²May 1998. Gunn, Steve. Support Vector Machines for Classification and Regression

Once the data has been imported, normalized and cleaned, Euqbits Foresight uses Support Vector Machine to build prediction models. Support vector machines are based on the structural risk minimization principle (SRM) (Vapnik, 1979) from computational learning theory. SVMs construct a hyper-plane that separates two classes (this can be extended to multi-class problems). Separating the classes with a large margin minimizes a bound on the expected generalization error. SVM supports the many kernels including: linear, RBF, polynomial and sigmoid. For further description of SVM algorithm, please read the following papers by Vapnik:
V. Vapnik. Estimation of Dependencies Based on Empirical Data. Nauka, Moscowm 1979.
V. Vapnik. Statistical Learning Theory. Wiley, 1998.
V. Vapnik and A. Chervonenkis. Theory of Pattern Recog-nition. Nauka, Moscow, 1974.

### Support Vector Classification

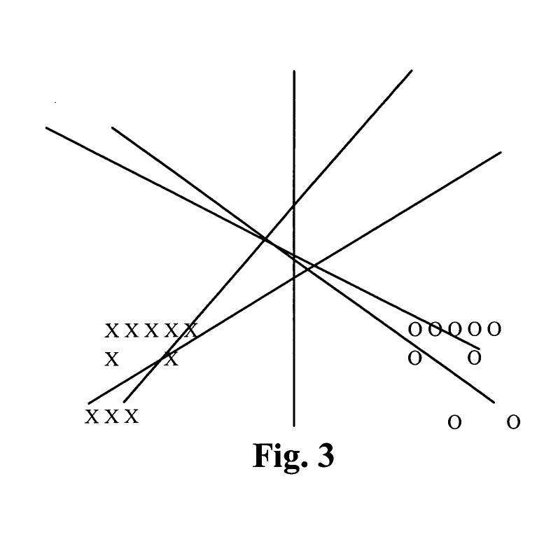

The classification problem can be restricted to consideration of the two-class problem without loss of generality. In this problem the goal is to separate the two classes by a function which is induced form available examples. The goal is to produce a classifier that will work well on unseen examples, i.e. it generalizes well. Consider the example on FIG. 3. Here there are many possible linear classifiers that can separate the data, but there is only one that maximizes the margin (maximizes the distance between it and the nearest data point of each class). This linear classifier is termed the optimal separating hyper-plane. Intuitively, we would expect this boundary to generalize well as opposed to the other possible boundaries.

SVM can also be used for regression by introducing a loss function. Normal regression procedures are often stated as the processes deriving a function f(x) that has the least deviation between predicted and experimentally observed responses for all training examples. Support Vector Regression attempts to minimize the generalization error bound so as to achieve a higher generalization performance. This generalization error bound is the combination of the training error and a regularization term that controls the complexity of hypothesis space.

SVM are proven to be very effective methods for predictive modeling. Different models can be produced for various combinations of optimization parameters. The following techniques can be used for building multiple models by varying the optimization parameter: Grid Search and Pattern Search.

### 6.1 Grid Search

In grid search, the user specifies the starting and ending values of each of the optimization parameter and also the steps at which they ought to be incremented. Multiple sessions are created based on the values and steps specified. Hence a whole matrix of models is produced for every combination possible by varying the optimization parameters. Equbits Foresight provides Grid Search as an option that user can specify.

6.2 Pattern Search or Auto Train Search³ ³Momma, Michinari; Bennet, Kristin. A Pattern Search Method for Model Selection of Support Vector Regression

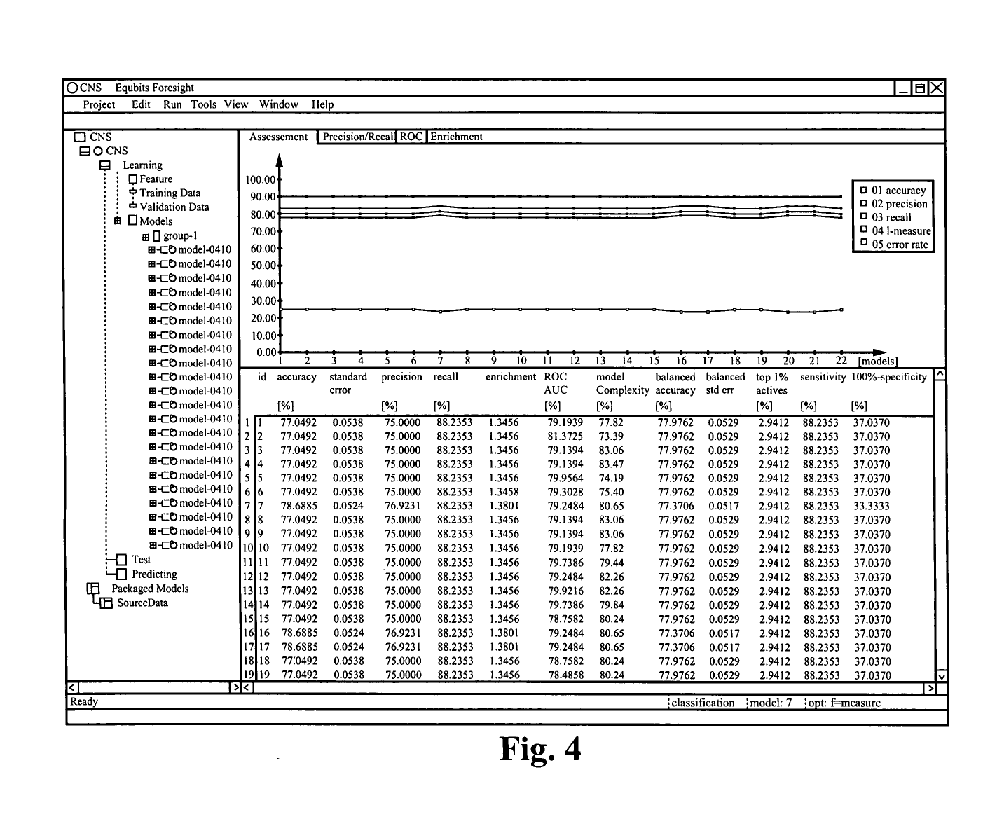

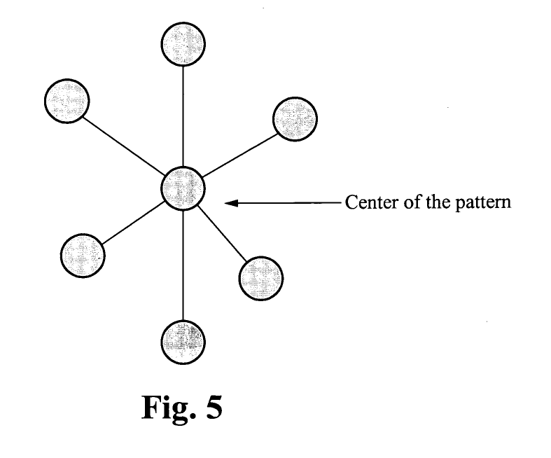

Equbits Foresight provides a proprietary implementation of Pattern Search or also known as Auto Train Search (ATS) which is a derivative-free optimization method suitable for low-dimensional optimization problems for which it is difficult or impossible to calculate derivatives. FIG. 4 illustrates an Auto-Train run in Equbits Foresight. ATS samples points in a search space in a fixed pattern about the current point. This algorithm calculates function values of the pattern and tries to find a minimizer. If it finds a new minimum, it changes the center of the pattern and re-iterates. If all the values in the pattern fail to produce a decrease, then the search step or pattern size is reduced by half. This search continues until the search step gets sufficiently small, ensuring convergence to a local minimum. Efficiency is gained by using pattern values as the pattern center moves. FIG. 5 illustrates a search space in a fixed pattern about the current point.

The ATS is based on pattern Pk defined as:

$$Pk = \begin{matrix}1 & 0 & 0 & - 1 & 0 & 0 & 0 \\ 0 & 1 & 0 & 0 & - 1 & 0 & 0 \\ 0 & 0 & 1 & 0 & 0 & - 1 & 0\end{matrix}$$

### 6.3 V-Fold Cross Validation

V-Fold cross validation helps to reduce over-fitting by sampling all datasets and then picking an optimization value that produces the best validation results. The positively and negatively labeled training examples are split randomly into n groups for n-fold cross validation such that as close to 1/n of the positively labeled examples are present in each group as possible (this is called balanced cross validation.) This balanced version of cross validation is necessary as there are very few positive examples in drug discovery datasets. The method is then trained on n−1 of the groups and is tested on the remaining group. This procedure is repeated n times each time using s different group for testing, taking the final score for the method as the mean of the n scores. The best configuration parameters are then picked based on model analysis and then the whole training dataset is retrained with the selected parameters. Equbits Foresight provides cross validation functionality.

### 6.4 One-leave-Out Cross Validation

In one-leave-out cross validation, number of v folds created is equal to the number of data-points. Hence each data-point is tested once against model trained on the rest of the data-points. Equbits Foresight provides One-leave-out cross validation.

### 6.5 Sub-sampling Validation

Equbits Foresight has a proprietary implementation of Sub-sampling Validation. In Sub-sampling Validation, a training dataset is divided into pools of x % increments. For instance, if the total number of training data-points is 3000 and dataset increment is specified to be 10% then it is split into the following pools of training sets: 300, 600, 900, 1200, 1500, 1800, 2100, 2400, 2700, 3000. Models are generated by training them using the 10 training sets and then validation is run against them using the same validation set to measure the accuracy of the models with varying number of data-points in the training set. A graph is plotted with number of data-points along the x-axis and accuracy plotted against the y-axis. This helps to determine of the model engine can yield accuracy with smaller datasets.

6.6 Boosting⁴ ⁴Meir, Ron; Ratsch, Gunnar. An Introduction to Boosting and Leveraging

Boosting is based on the observation that finding many not-so-accurate models can be a lot easier than finding a single, highly accurate prediction model. To apply the boosting approach, we start with a method or algorithm for finding moderately accurate models. The boosting algorithm calls this “weak” or “base” learning algorithm repeatedly, each time feeding it a different subset of the training examples (or, to be more precise, a different distribution or weighting over the training examples 1). Each time it is called, the base learning algorithm generates a new weak model, and after many rounds, the boosting algorithm must combine these weak models into a single model that, hopefully, will be much more accurate than any one of the weak models.

To make this approach work, there are two fundamental questions that must be answered: first, how should each distribution be chosen on each round, and second, how should the weak rules be combined into a single rule? Regarding the choice of distribution, the technique that is advocated by Robert Schapire is to place the most weight on the examples most often misclassified by the preceding weak rules; this has the effect of forcing the base learner to focus its attention on the “hardest” examples. As for combining the weak rules, simply taking a (weighted) majority vote of their predictions is natural and effect of forcing the base learner to focus its attention on the “hardest” examples. As for combining the weak rules, simply taking a (weighted) majority vote of their predictions is natural and effective for classification. A weighted average of the predictions is used for regression.

An actual training set is selected from the available training patterns for T different classifiers. However, the general idea in Boosting is that which patterns are selected for the I-th training set, is dependent on the performance of the earlier classifiers. Examples that are incorrectly predicted (more often) by previous classifiers are chosen more often for subsequent classifiers. A probability pj of being selected for the next training set is associated with each pattern j, j belonging to {0, 1, . . . , 1train−1}. Initially, of course, pj=1/train. To construct an actual training set, repeat 1 train times: Choose pattern j with probability pj. For subsequent classifiers, the pj are changes. The way in which pj are changed depends on which variant of Boosting is used.

### 6.7 Bagging

Bagging was proposed by Breiman [4], and is based on bootstrapping [7] and aggregating concepts, so it incorporates the benefits of both approaches. Bootstrapping is based on random sampling with replacement. Therefore, taking a bootstrap replicate X=(X1, X2, . . . , Xn) (random selection with replacement) of the training set (X1, X2, . . . , Xn), one can sometimes avoid or get less misleading training objects in the bootstrap training set. Consequently, a classifier constructed on such a training set may have a better performance. Aggregating actually means combining classifiers. Often a combined classifier gives better results than individual classifiers, because of combining the advantages of the individual classifiers in the final solution. Therefore, bagging might be helpful to build a better classifier on training sample sets with misleaders. In bagging, bootstrapping and aggregating techniques are implemented in the following way:

### Classification:

1. The same split percentages is used for randomly creating multiple (training and validation) datasets.
1. For each dataset (training and validation), the best model is produced.
2. The models are aggregated by a simple majority rule. The models that produce the majority classification for a molecule are aggregated to produce the bagged model.

### Regression:

1. The same split percentages is used for randomly creating multiple (training and validation) datasets.
2. For each dataset (training and validation), the best model is produced.
3. The models are simply aggregated by averaging the models.

### 7. Model Assessment and Model Selection

The following results are calculated for various models:

N—total number of all points (vectors, lines) in the test data
A—number of points correctly classified as positive
B—number of points incorrectly classified as positive
C—number of points incorrectly classified as negative
D—total number points correctly classified as negative

### 7.1 Classification:

Accuracy: A measure (%) of the models ability to correctly classify a molecule

$${A}_{cr} = \frac{A + D}{N} * 100 \%$$

Precision: A measure (%) of the model's ability to predict whether a molecule is active or inactive

$$P = \frac{A}{A + B} * 100 \%$$

Recall: A measure on the model's ability to predict all the active molecules (100—false negative rate)

$$R = \frac{A}{A + C} * 100 \%$$

Specificity (True Negative Rate): The probability of predicting a negative given its true state is negative

S=(TN/(TN+FP))*100

Enrichment: A measure of the ratio between the percentage of actives your model accurately predicts compared to the percentage actives found through random selection

$$E = \frac{P}{\frac{A + C}{N}}$$

### F-Measure:

F-measure

$${F}_{b} = \frac{( {b}^{2} + 1 ) PR}{{b}^{2} P + R}$$

b=0 means F=precision
b=∞ means F=recall
b=1means recall and precision equally weighted
b=0.5 means recall is half as important as precision
b=2.0 means recall is twice as important as precision
(because 0≦P, R≦1, a larger value in the
denominator means a smaller value overall)

We recommend using b=2.0 in order to put twice as much emphasis on recall as precision.

Balanced Error Rate(BER) BER=(Active Error Rate+Inactive Error Rate)/2

Balanced Standard Error(BSE)BSE=(Active Standard Error+Inactive Standard Error)/2

Balanced Accuracy(BA) BA=(Active Accuracy+Inactive Accuracy)/2

Model Complexity=Total number of support vectors/Total number of training datapoints

### 7.2 Auto-Threshold Tuning for Classification

After the SVM engine produces a model for a specific set of optimization parameter that predicts the y-values for the learning dataset using grid search or pattern search, the following algorithm is used for selecting different thresholds in order to produce results that vary in accuracy, precision, recall et al.
1. A1 the predicted values are sorted from highest to lowest values. A default threshold of 0 is initially selected. All positive values are considered ‘active’ and all negative values are considered ‘inactive’. The predicted values are compared against the ground truth to calculate accuracy, precision, recall, enrichment. F-measure et al. against the ground truth.
2. Assume highest value=Nhigh and the lowest value is Nlow. Range is calculated as follows: Nhigh-Nlow
3. Assume threshold steps=Ts. Hence, threshold increments is calculated as follows: Ti=Range/Ts
4. Set T=Nlow, While (T<=Nhigh), calculate threshold (T)+=Ti
5. For this new threshold, assume all values above it to be ‘active’ below it to be ‘inactive’. Calculate accuracy, precision, recall, enrichment, F-measure et al. against the ground truth.

### 7.3 Regression:

Root Mean-Square Error (RMSE): The Root Mean-Square Error is a measure of the “spread” in the predicted data.

$$RMSE = \sqrt{( {\sum }_{i = 1}^{N} {( {GT}_{i} - {PR}_{i} )}^{2} ) / N}$$

Squared Correlation Coefficient (R²-value): If the experimental values are plotted against the predicted values, a regression line can be fitted to the data points. This line corresponds to the ideal result, and a measure of the performance of the model is then how well the points fit the line. In linear regression theory, the R²-value is used as such a measure. R²-value runs between 0-1.

### Mean Ground Truth is

$$MG = \frac{{\sum }_{i = 1}^{N} {GT}_{i}}{N}$$

### Mean Prediction is

$$MP = \frac{{\sum }_{i = 1}^{N} {PR}_{i}}{N}$$

### Prediction Sigma is

$$PS = {\sum }_{i = 1}^{N} {( {PR}_{i} - MP )}^{2}$$

### Ground Truth Sigma is

$$GS = {\sum }_{i = 1}^{N} {( {GT}_{i} - MG )}^{2}$$

### Cov is

$$Cov = {\sum }_{i = 1}^{N} ( {GT}_{i} - MG ) * ( {PR}_{i} - MP )$$

### R² is

$${R}^{2} = \frac{\frac{Cov * Cov}{PS}}{GS}$$

RMSE and R²-value allow us to determine the accuracy of the results and compare the predictive abilities of the methods on different data sets. The goal of a tuning exercise is to reduce RMSE where as maximize the R²-value towards 1.

When RMS=0, R2=1. RMS is the error where as R2 is the correlation between the observed and the y value. In other words, when there is no error, correlation is high. So the idea in regression is to reduce RMS and maximize R2 towards 1.

$$\begin{matrix}Mean Absolute & Mean Absolute Error ( MAE ) is calculated as follows : \\ Error & MAE = ( SUM ( ABS ( P\_i - T\_i ) ) ) / n where \\ & P\_i = predicted value , T\_i = truth , n = number of datapoints \\ & Mean Relative Error ( MRE ) is calculated as follows : \\ & MRE = ( SUM ( ABS ( P\_i - T\_i ) ) ) / n where \\ Mean Relative & P\_i = predicted value , T\_i = truth ; n = number of datapoints . \\ Error & MRE will be displayed as ‘ NA ’ ( not applicable ) when any of the ground \\ & truth ( T\_i ) value is 0.\end{matrix}$$

### 7.4 Error Analysis

In order to calculate error rate, lets first define Loss Function (LF):

X=Input vector
Y=output class
f(X)=model
LF for measuring errors between Y and f(X) is denoted by L(Y,f(X)) can be calculated as follows:

| | |
|---|---|
| LF(Y, f(X)) = (Y − f(X))\hat{ }2) | squared error |
| or | |
| LF(Y, f(X)) = \|Y − f(X)\| | absolute error |

We can use absolute error for our purposes. Hence, for example, in case of classification, the following four combinations are possible using absolute error:

### LF (1,1)=0

### LF(0,0)=0

### LF(1,0)=1

### LF(0,1)=1

(Assuming 1=Active, 0=inactive in Two Class Classification)

For regression, the loss functions are calculated based on predicted and experimental y values.

### 7.5 Error Analysis for Single Split Training and Validation Datasets

We perform a single split and select a set of optimization parameters for training/validation. If this is a classification problem, then once training has been performed, we perform validation using multiple thresholds (assume T number of thresholds).

For each threshold value, we calculate validation error rate for that threshold as follows:

errate=Sum(LF across all inputs in the validation set)/(Total number of element in the validation set)

The error bar for each threshold is calculated as follows:

error bar+sqrt(errate.(1−errate)/(total number of elements in the validation set))

Once we have calculated error rate and error bars for all the thresholds, we then select the best model for that single split as follows:

a) Keep the set of classifiers that are within 1 error bar of the best classifier.
b) Within that set, we will select the “simplest” classifier as follows:
i) linear classifier is simpler than other kernel classifiers
ii) select the models that maximize F-measure (F-measure is defined in order to maximize recall)
iii) fewer support vectors is better

In case of classification, the selected threshold model using the steps above then becomes the default model for that split session.

### 7.6 Error Analysis for Cross Validation

Given the above definition of LF, now we can define error rate for cross validation as follows: Assume we have K folds. We run CV with a tuning parameter combination (C,gamma and epsilon in case of regression), on K−1 folds. We do this K times for each of the K folds. It generates K models. For each of the K models, in case of classification, the best threshold is picked using the process above described in the Single Split section.

Then the training/validation error rate for each of the K folds is calculated as follows:

errate=Sum(LF across all inputs in the validation set)(Total number of element in the validation set)

The error bar for that CV session is calculated as follows:

error bar=(stdev of K errates)/sqrt(K−1)

We then use the following rules to select the best model as follows:

(a) select the models that maximize F-measure (default) or optimizes on a user selected optimization parameter

### 7.7 ROC Graph

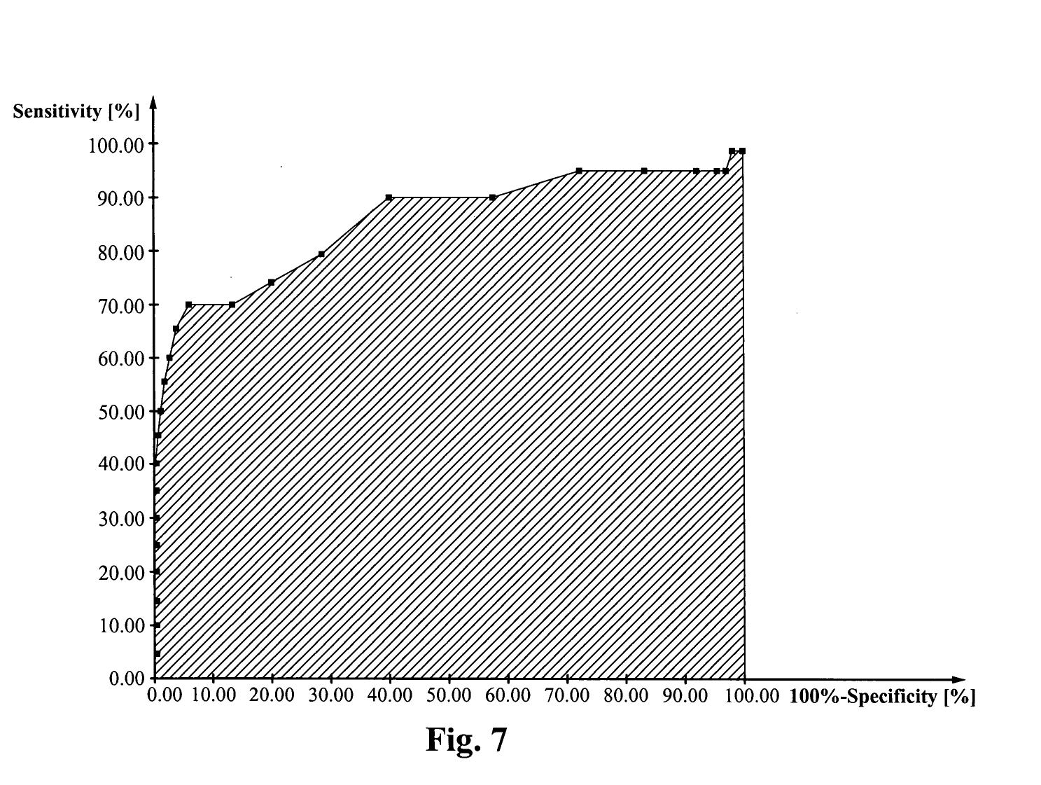

Receiver Operator Curve (ROC) graphs are another way besides to examine the performance of classifiers (Swets, 1998). FIG. 7 illustrates a ROC Graph in Equbits Foresight. A ROC graph is a plot with the false positive rate on the X axis and the true positive rate on the Y axis. The point (0,1) is the perfect classifier: it classifies all positive cases and negative cases correctly. It is (0,1) because the false positive rate is 0 (none), and the true positive rate is 1 (all). The point (0,0) represents a classifier that predicts all cases to be negative, while the point (1,1) corresponds to a classifier that predicts every case to be positive. Point (1,0) is the classifier that is incorrect for all classifications. In many cases, a classifier has a parameter that can be adjusted to increase TP at the cost of an increased FP or decrease FP at the cost of a decrease in TP. Each parameter setting provides a (FP, TP) pair and a series of such pairs can be used to plot an ROC curve. A non-parametric classifier is represented by a single ROC point, corresponding to its (FP, TP) pair.

Area Beneath the Graph: The area beneath a ROC curve can be used as a measure of accuracy in many applications (Swets, 1988).

### 7.8 Confusion Matrix

Confusion matrix is a simple matrix representation to show the number of true positives, true negatives, false positives and false negatives.

7.9 Enrichment Curve

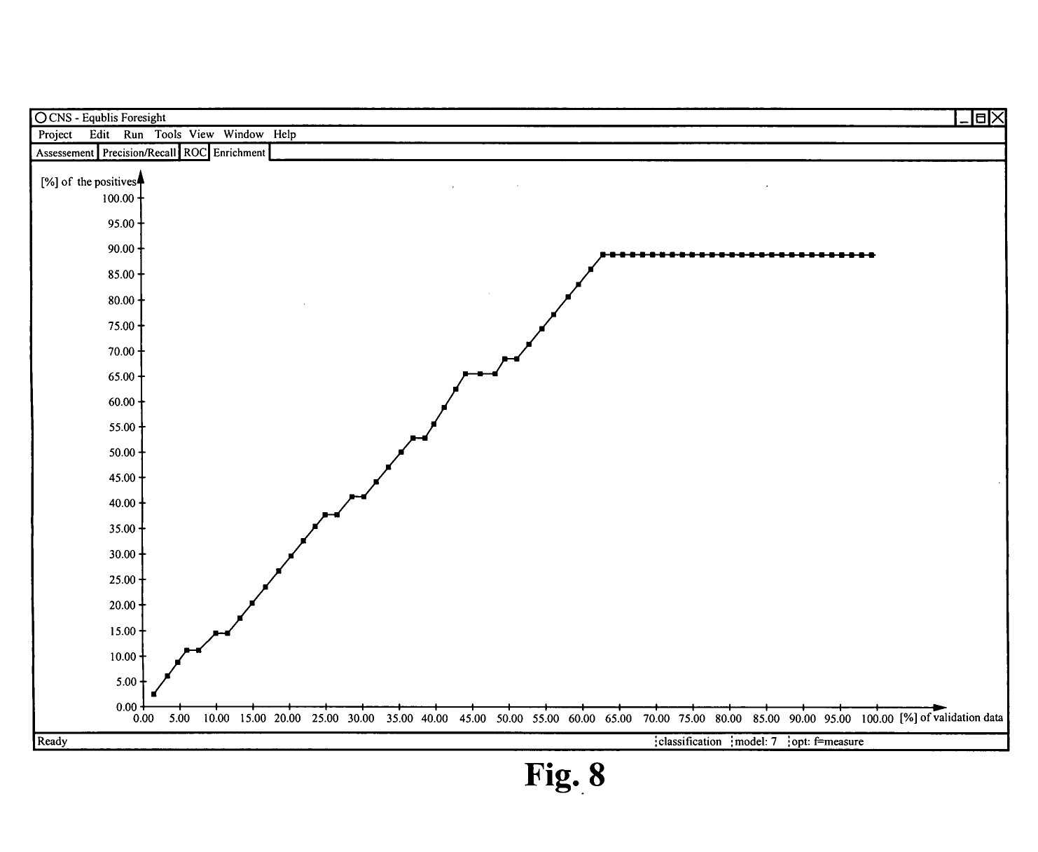

Enrichment Curve displays the percentage of true positives discovered in the top percentage of data-points ranked in the order of their likelihood of being positive. FIG. 8 illustrates an Enrichment Curve in Equbits Foresight. Let's say you have a model and you have run a set of compounds with ground truth and you want to know how to plot enrichment. For Support Vector Machines, typically, each compound has a score for how “likely” it belongs to a class (actives for example). If you could imagine, every compound has a likelihood or probability for it being active. If you were to create a list of compounds sorted by highest probability to lowest probability, how many true positives would you find as you go down the list. At any point in the list, you would know the percentage of true positives you have and the percentage of compounds evaluated.

### EXAMPLE

You generated a model and you want to test the model. You have some ground truth data and you run them:

100 compounds
5 of them positives

You run the system and it ranks and list them from highest probability of the compound being a positive to lowest. You examine the list and find that 2 true positives are in the first 10 compounds listed and 5 true positives are in the first 20 listed.

That means you have 40% true positives in 10% of the database. Your second point is 100% true positives in 20% of the database.

Foresight Desktop should plot a point on an Enrichment Curve for every threshold for the selected model. True positives is along the y-axis. % of the database is along the x-axis.

### 7.10 Result Ranking

Ability to sort the data points from most likely to be in a particular class (active) to least likely based on the y-value that specifies the distance from the hyperplane.

### 8. Dominant Feature Selection & Ranking

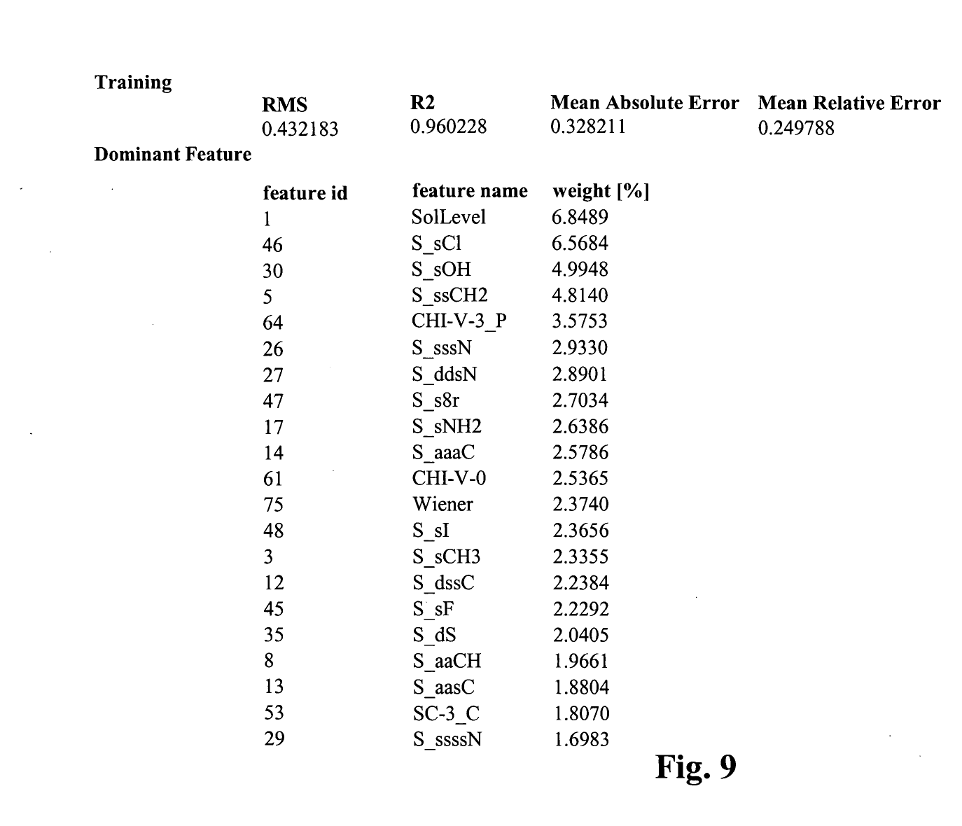

FIG. 9 illustrates Dominant Feature Ranking in Equbits Foresight.

The objective of feature selection and discovery is three-fold: improving the prediction performance of the predictors, providing faster and more cost-effective predictors, and providing a better understanding of the underlying process that generated the data.

Dominant features can be discovered for linear as well as non-linear kernels with Support Vector Machines. We describe below a proprietary methodology called “Non-Linear Feature Selection for Support Vector Machine”.

### 8.1 Non-linear Feature Selection for Support Vector Machines

Here by we describe a feature selection strategy which defines weights for independent features on the basis of a single training run. Being especially designed for support vector machines, this technique reorders the feature dimensions according to their relative importance to the classification decision based on the support vectors discovered by a single training run. This approach is applicable to non-linear kernels and hence makes it extremely important as it is capable of discovering dominant features based on their non-linear relationships with each other.

### Inputs:

1. X=model file; n=number of support vectors, p=number of features

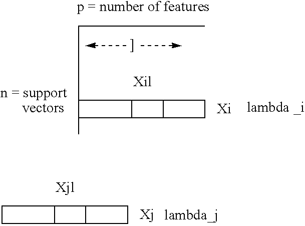

2. Optimization parameter gamma value; column vector of lambda (Lagrange multiplier) for the support vector

### Output:

1. RBF kernel matrix Kij=K(Xi,Xj) calculated as follows:

D=∥Xi−Xj∥̂2

where
SUM (Xi1−Xj1)̂2 where 1=1 to p
K is an n×n matrix calculated as follows:

Kij=ê(−gamma*Dij)

Every support vector Xi is comparted with every other support vector Xj

2. Fitted function f−K.lambda
where
K=n×n matrix calculated in 1
lambda=Lagrange multiplier for each support
3. A=n×p matrix; each cell has a value alpha_ij
A=gamma*[Diag(f_i).X−K.D_lambda.X]
4. Diag(f_i).X is calculated as follows=f_i*X_ij which yields a matrix of n×p dimension
5. D_lambda.X is calculated as follows=lambda_i*X_ij where lambda_i is the first value in the model file for each row of support vector
6. K.D_Lambda.X is then calculated which should yield a n×p matrix
7. Calculate A by the formula given in 3 to yield a matrix n×p where each cell is an alpha_ij value
8. For each row in A, compute the norm as follows:

n_{—}i=SQRT(SUM(alpha_{—}iĵ2))

A_norm=Divide each element alpha_ij in the ith row of matrix A by n_i. Yields A_norm which is a normalized vector of A; each element in A_norm is alphanorm_ij

9. Compute the following two values for each element alphanorm_ij in A_norm:

Q1_{—}ij=arc cos(alphanorm_{—}ij) and

Q2_{—}ij=PI−arc cos(alphanorm_{—}ij)

10. Set alphanorm_ij=min [Q1_ij, Q2_ij}
11. Normalize alphanorm_j to [0-1] as follows:

alphanormalized_{—}ij=1−[(2/PI)*alphanorm_{—}ij]

12. Take the mean of alphanormalized_j as the aggregated weight for feature j

### 8.2 Linear Feature Selection for Support Vector Machine

An embedded approach of using the linear SVM directly to rank the features can also be used with linear kernels. Linear SVM can be used to rank the features as follows:
1. Build a suitable model with linear SVM
2. For each feature Fi calculate the absolute value of the sum of alphaY times the feature value for the support vectors in the model.
3. The ranking of a feature Fi is the percentage of the value in step 2 divided by the sum of all features values

That is,

Ai=ABS(Sum(AlphaY*Xji))

Fi=Ai/(Sum of all Ai)
Where
   Ai=Absolute value of the sum of all alpha Y times the feature value in the input vector X
   Fi=Rank of feature i

### 9. Dimensionality Reduction Post Model Generation

Once a suitable model has been identified along with the kernel optimization parameters, it may still be beneficial to further reduce the number of features in order to gain further performance efficiency as well as further improvement in accuracy. Equbits Foresight implements the methodologies described below in order to further reduce the features after a model has been generated.

Equbits Foresight also allows to select and freeze user selected features so that they do not get eliminated as part of dimensionality reduction. Chemists and modelers often know that certain features and descriptors are important for modeling and hence they can provide a hint to the algorithm to preserve the selected feature/s.

### 9.1 Forward Selection and Backward Elimination

Once features have been ranked using one or more of the above methodologies, we can use Forward Selection and/or Backward Elimination methodologies to reduce feature dimensionality.

In Forward Selection, features are progressively incorporated into larger and larger subsets and then continue incorporating as long as accuracy of the models continue to improve based on model assessment strategies discussed in later sections. In Backward Elimination, one starts with the set of all variables and then progressively eliminates the least promising ones while re-creating the models with the selected optimization parameters.

Both methodologies can yield good results depending on the correlation of the features. Forward Selection is computationally more efficient than backward elimination to generate subsets of relevant and useful features. However, Forward Selection may only discover weaker subsets because the importance of variables is not assessed in context of other variables not included yet.

9.2 Zero-norm Backward Elimination⁵ ⁵J. Weston, A. Elisseeff, M. Tipping and B. Scholkopf. “Use of the zero norm with linear models and kernel methods” JMLR special Issue on Variable and Feature selection, 2002.

Assume you have trained with a linear SVM:

y=w′.x+b

where w=sum_k alpha_k y_k x_k is the weight vector.

You may first normalize w:

w<−w/|w|

where |w|=sqrt (sum_i w_î2)

then you can use the resulting w_i as scaling factors:

x_{—}i<−w_{—}i x_{—}i

Then you iterate: retrain the SVM, rescale the x_i. Promptly some x_i go to zero.

### 10. Correlation Discovery

It is important for the modeler to discover the correlated features to the dominant features in order to gain further insight into the features and characteristics of the bioactive molecules. Several characteristics of the feature sets can influence the outcome of the predictive model.

They are:
Perfectly correlated variables are truly redundant in the sense that no additional information is gained by adding them.
A variable that is completely useless by itself can provide a significant performance improvement when taken with others.
Two variables that are useless by themselves can be useful together.

When collecting multivariate data it is common to discover that there exists multi-collinearity in the variables. One implication of these correlations is that there will be some redundancy in the information provided by the variables.

It is the goal of any feature selection and dimensionality reduction process to minimize the negative influence of these characteristics mentioned above, if they exist, on the accuracy of the model while discovering the best set of features in the most cost and time effective fashion and providing deeper insight into the molecular properties that influence the activity. We propose the following algorithms and methodology to overcome these challenges.

### 10.1 Correlation Coefficient

### Fischer Score

Fischer Score is a standard univariate correlation score calculated as follows:

Fj=(((Uj(+)−Uj(−))̂2/((Sj(+))̂2+(Sj(−))̂2)

### Where

Fj=Score of feature j
U(+)=mean of the feature values for the positive examples
U(−)=mean of the feature values for the negative examples
S(+)=Standard deviation of U(+)
S(−)=Standard deviation of U(−)

We recommend using Fischer Score if there are a small number of features and the data is somewhat balanced.

### 10.2 Unbalanced Univariate Correlation

We propose the following univariate feature selection criterion, which we call the unbalanced correlation score. Rank the features according to the criteria:

Fj=SumOfAllActiveDatapoints(Xij)−Y*SumOfAllNegativeDatapoints(Xij)

### Where

Fj=Score of feature j
X=Training data where columns are features and data-points are rows
Y=Constant. Very large value in order to select features which have non-zeros entries only for active examples.

This score is an attempt to encode prior information that the data is unbalanced, has a large number of features and only positive correlations are likely to be useful. A large score is assigned a higher rank. A univariate feature selection algorithm reduces the chance of over-fitting. However, if the dependencies between the inputs and the targets are too complex then this assumption maybe too restrictive.

### 10.3 Multivariate Unbalanced Correlation

We can extend our criterion to assign a rank to a subset of features rather than just a single feature to make the algorithm multivariate. This can be done by computing the logical OR of the subset of features S (if they are binary), i.e. Xi(S)=1−OR(1−Xij) and then evaluating the score on the vector X(S). A feature subset that has a high score could thus be chosen using, for example, a greedy forward selection scheme (see e.g. Kohavi (1995)).

11. Cluster Analysis⁶ ⁶Hastie, Trevor; Tibshirani, Robert; Friedman, Jerome. The Elements of Statistical Learning

Cluster analysis is the process of segmenting observations into classes or clusters so that the degree of similarity is strong between members of the same cluster and weak between members of different clusters.

Hierarchical clustering is a technique where by multiple clusters can be discovered on a hierarchy. Hierarchical clustering requires the user to specify a measure of dissimilarity between disjoint groups of data points based on pairwise dissimilarities among the observations in the groups based on a similarity matrix calculated as part of a SVM training run. This produces hierarchical representations in which the clusters at each level of the hierarchy are created by merging clusters at the next lower level. At the lowest level, each cluster contains a single observation. At the highest level there is only one cluster containing all of the data.

A user can then create multiple clusters by specifying a cut-off point in the hierarchy. Once clusters have been established, non-linear feature selection for non-support vectors (described above in section 9) can then be applied to the various clusters to discover dominant features for each of the clusters separately.

### 12. Noise Discovery

Noise Reduction is the process whereby Equbits Foresight calculates the noise present in the training dataset. This is done by cross-validating a training set and then attaching a confidence level to the classification of a particular compound. The confidence level vis-a-vis the experimental y-values will essentially specify the correctness of the experimental y-values thus helping to quantify noise in the dataset which can help to reduce the false negatives.

### Noise Discovery Cross-Validation Algorithm:

1. Take the entire dataset and separate the positives from the negatives.
2. Split the negatives into n folds.
3. Take all the positives and merge it with one of the negative folds to create a training sample.
4. Run pattern search and find the best model.
5. Take the rest of the n−1 folds and predict them against the selected model.
6. Repeat steps 3-5 with every n fold. In step 4, we can just use the optimization parameters from the first run instead of running PS for subsequent folds.
7. Each negative compound in the n folds would have n−1 predicted y values. Count the number of positive and negative predictions for each compound. That becomes the confidence level for the compound.

### 13. Testing

### 13.1 Transductive Inference

In “Transductive Inference” in contrast to inductive inference, one takes into account not only the given training set but also the testing and prediction sets that one wishes to classify in order to improve predictions.

Transductive Inference can be useful when the one cannot expect the data to come from a fixed distribution of distributions. In drug design environment, for instance, different batches of compounds do not have random noise levels and hence cannot be expected to come from a common distribution as the training example. The training example is thus not fully representative of the test example.

Hence, in contrast to the inductive inference methodology, transductive inference builds different models when trying to classify different test sets based on the same training set.

Note that a transductive method can but does not need to improve the prediction for a second independent test set of data: the result is not independent from the test et of data. It is this characteristics that can help to overcome the challenge when data we are given has different distributions in the training and test sets.

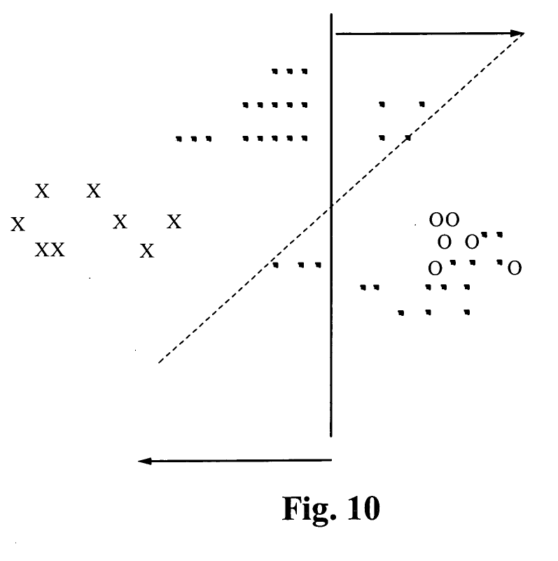

FIG. 10 demonstrates transductive inference. The training set is detonated as a circle and crosses symbols for the two classes. The test set which has a different distribution than the training set, is detonated as dots, the labels for which are unknown.

We propose to use a transductive scheme inspired by the ones used in Vapnik (1998); Jaakola et al. (2000); Bennet and Demiriz (1998) and Joachims (1999).

### 14. Prediction

The selected model can then be used to perform predictions on unknown datasets. Bagging and Transductive Interference can be used to improve the accuracy of the predicted results.

Chemists are also interested in discovering features that play a dominant role in defining the outcome of the prediction relative to the hyper-plane. This allows them to gain insight into the characteristics and structure of the compound that renders it useful.

Non-linear Feature Selection for Non-Support Vector Algorithm

### Inputs:

1. X=model file; n=number of support vectors, p=number of features.

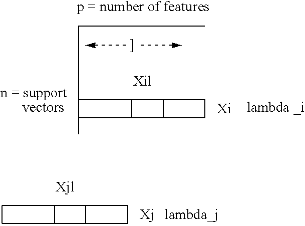

2. Optimization parameter gamma value; column vector of lambda for the support vector.
3. X*=another dataset; m=number of observations; p=number of features.

### Output:

1. RBF kernel matrix K*ij=K*(X*i,Xj) calculated as follows:

D=∥X*i−Xj∥̂2

where
Sum (X*i1−Xj1)̂2 where 1=1 to p
K is an n×m matrix calculated as follows:

K*ij=ê(−gamma*D*ij)

Support vector X* is compared with every other support vector Xj
2. Fitted function f*=K*.lambda
where
K=n×n matrix calculated in 1
lambda=Lagrange multiplier for support vectors
3. A=n×p matrix; each cell has a value alpha_ij
A=gamma*[Diag(f_i)*.X*−K*.D_lambda.X]
4. Diag (f_i)*.X* is calculated as follows=f_I* *X*_ij which yields a matrix of n×p dimension
5. D_lambda.X is calculated as follows=lambda_i*X_ij where lambda_i is the first value in the model file for each row of support vector
6. K*.D_lambda.X is then calculated which should yield a n×p matrix
7. Calculate A by the formula given in 3 to yield a matrix n×p where each cell is an alpha_ij value
8. For each row in A, compute the norm as follows:

n_{—}i=SQRT(SUM(alpha_{—}iĵ2))

A_norm=Divide each element alpha_ij in the ith row of matrix A by n_i. Yields A_norm which is a normalized vector of A; each element is A_norm is alphanorm_ij

9. Computer the following two values for each element alphanorm_ij in A_norm:

Q1_{—}ij=arc cos(alphanorm_{—}ij) and

Q2_{—}ij=PI−arc cos(alphanorm_{—}ij)

10. Set alphanorm_ij=min [Q1_ij, Q2_ij]
11. Normalize alphanorm_j to [0-1] as follows:

alphanormalized_{—}ij=1−[(2/PI)*alphanorm_{—}ij]

12. Take the mean of alphanormalized_j as the aggregated weight for feature j

### 15. Similarity Discovery

Similarity Discovery allows one to discover if two separate datasets come from the same series and similar distribution. Clustering can also be used for discovering similarity between datasets such as training and testing. Clustering, as described above in section 11, is performed on the two datasets separately using the above algorithm. Then for each pair of observations in every cluster in the 1^{st} dataset, find its cluster assignment in the second dataset using average, min, or max.distance. If the pair gets assigned to the same cluster then it's a positive match. You do it for all pairs of observations in the first dataset. Then you calculate the similary ratio=number of positive matches/total number of observations (tanimoto ratio). This ratio expresses how similar the datasets are and indicates if the prediction dataset comes from the same distribution or series as the training dataset.

### 16. Packaging and Exporting Data and Model

Equbits Foresight provides the ability to easily package and export data, results and model to external third party applications. Data can be easily exported in CSV format to be viewed within Excel. Models can be exported to be used within other applications via Predictor SDK which is a standalone command line executable is called predict.exe. Predictor CLI can be used to easily and seamlessly integrated models generated by Equbits Foresight into any third party applications to facilitate automated predictions.

### 17. Retrain Local Models with Additional User Data

Equbits Foresight allows users to add in their own data and “retrain” to build a new model. SVM is computational time is n*n*nFtrs, where n is the number of data points. In case the algorithm used for training and producing the original best model was Support Vector Machines then by eliminating the data points that are not used as support vectors with the original data set then the training set will be much smaller thus reducing the training time by n*n. Thus if the complexity is 50% you will reduce the “retraining” time by 4×. If the complexity is 25% you will reduce the “retraining” time by 8×.

### 18. Incremental Learning

Incremental Learning refers to adding new training without having to re-run the model. Let's say you want to add 100 new molecules to a dataset of 10000. Rather than generating a new model, you can incrementally add those molecules to the model to improve its ability to predict more accurately.⁷ ⁷G. Cowenberghs, T. Poggio. “Incremental and Decremental SVM Learning”

There has thus been outlined, rather broadly, the more important features of the invention in order that the detailed description thereof that follows may be better understood, and in order that the present contribution to the art may be better appreciated. There are additional features of the invention that will be described hereafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purpose of the present invention. It is important, therefore, that the claims be regarded as including such equivalent constructions insofar as they do not depart from the spirit and scope of the present invention.

Further, the purpose of the foregoing abstract is to enable the U.S. Patent and Trademark office and the public generally, and especially the scientists, engineering and practitioners in the art who are not familiar with patent or legal terms or phraseology, to determine quickly from a cursory inspection the nature and essence of the technical disclosure of the application. The abstract is neither intended to define the invention of the application, which is measured by the claims nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

1. A method and apparatus for predictive modeling & analysis for knowledge discovery comprising:
selecting a specific target for which predictive modeling and analysis is to be performed;
importing the dataset into learning and testing data sets;
learning dataset is further divided into training and validation datasets;
normalizing and cleaning the dataset;
systematic dimensionality reduction of features from the learning dataset in order to improve the performance of creating models without sacrificing speed;
configuring the apparatus for either a single-class or multi-class classification modeling or a regression modeling or optionally both;
optionally selecting an appropriate linear or non-linear kernel for modeling;
selecting an auto-tuning parameter for automatically optimizing and selecting the best model with the highest accuracy for correct predictions of activity including selecting a linear or non-linear kernel that yields the best model with the highest accuracy;
creating models using support vector machines and other algorithms such as Naive Bayes, Random Forest, Ridge Regression with the learning dataset and auto-selecting the best model with the best accuracy for correct predictions of activity;
testing the test dataset against the auto-selected best model to determine over-fitting;
discovering dominant features and characteristics as in the learning dataset for the given target and the selected model;
performing cluster analysis on the learning dataset to discover different classes and series of similar data-points and discovering dominant features and characteristics of each cluster;
further systematic dimensionality reduction of features from the learning dataset in order to further improve accuracy based on the selected auto-tuning parameter;
iteratively re-creating models using support vector machines or other algorithms including Naïve Bayes, Random Forest and Ridged Regression with the learning dataset with reduced features and then auto-selecting the best model with the best accuracy for correct predictions of activity;
discovering noise in the training dataset by performing Noise Discovery Cross Validation Algorithm.
predicting activity and level of activity of data-points with unknown ground truth using the selected best model;
discovering dominant features and characteristics of the data-points in the prediction dataset for the given target;
performing similarity discovery to discover if the prediction dataset and training dataset come from similar distribution and series;
packaging and exporting models to be integrated and used with other third party applications;
recreating the best model by only training on the support vectors in case the algorithm used for training is Support Vector Machines;
allowing users to add additional data to the original training dataset for retraining and generating local models that are more specific to the users problem domain;
ability to perform incremental learning by adding new training data to improve the model without having to re-run and re-generate model.

2. A method and apparatus for predictive modeling & analysis for knowledge discovery according to claim 1 wherein Qualitative Structural-Property Relationship (QSPR) analysis is to be performed then it is required to generate molecular descriptors, structural keys, signatures, or molecular fingerprints (or, more simply, fingerprints) from molecular structures represented in molecular structure file formats including: SMILES (the Simplified Molecular Input Line Entry System proposed by Dave Weininger [Weininger, 1988]8), SDF, MOL or MOL2;

3. A method and apparatus for predictive modeling & analysis for knowledge discovery according to claim 1 wherein dual-class classification problem with very large unbalanced dataset with a small fraction of data-points belonging to the positive class and majority of the data-points belonging to the negative class can be further reduced by including a smaller quantity of data-points with a negative class where the quantity of data-points with a negative class is five times that of the total number of data-points with positive class;

4. A method and apparatus for predictive modeling & analysis for knowledge discovery according to claim 1, wherein data normalization can either be achieved by a 0-1 scaling or it can be achieved by a unit scaling;

5. A method and apparatus for predictive modeling & analysis for knowledge discovery according to claim 1, wherein data cleaning can be achieved by eliminating the feature with the same value;

6. A method and apparatus for predictive modeling & analysis for knowledge discovery according to claim 5, wherein data cleaning can be achieved by providing adequate values for missing feature values in the dataset;

7. A method and apparatus for predictive modeling & analysis for knowledge discovery according to claim 1, wherein discovering dominant features and characteristics with non-linear relationships in the learning dataset for the given target can be achieved for non-linear kernel using a Non-linear Feature Selection for Support Vector Machine algorithm;

8. A method and apparatus for predictive modeling & analysis for knowledge discovery according to claim 1, wherein discovering dominant features and characteristics in the learning dataset for the given target can be further enhanced to discover correlation between dominant features and features correlated to the dominant features in the learning dataset by using correlation coefficient algorithm based on Fischer Score, Unbalanced Univariate Correlation and Multivariate Unbalanced Correlation;

9. A method and apparatus for predictive modeling & analysis for knowledge discovery according to claim 1, wherein feature dimensionality of the modeling dataset can be reduced by backward and/or forward elimination algorithms;

10. A method and apparatus for predictive modeling & analysis for knowledge discovery according to claim 1, wherein models are created and auto-selected using grid search algorithm;

11. A method and apparatus for predictive modeling & analysis for knowledge discovery according to claim 1, wherein models are created and auto-selected using pattern search (also known as auto train) algorithm;

12. A method and apparatus for predictive modeling & analysis for knowledge discovery according to claim 1, wherein models are created and auto-selected using svmPath⁹ that computes the entire solution path for the two-class SVM model. The solution is calculated for every value of the cost parameter C, essentially with the same computing cost of a single SVM solution;

13. A method and apparatus for predictive modeling & analysis for knowledge discovery according to claim 1, wherein created models for classification can be assessed and compared based on Error Rate, Accuracy, Precision, Recall, Enrichment Curve, F-Measure, model complexity, ROC graph, Balanced Error Rate, 1% of Actives, Balanced Standard Error, Balanced Accuracy and Model Complexity;

14. A method and apparatus for predictive modeling & analysis for knowledge discovery according to claim 1, wherein created models for regression can be assessed and compared based on RMS, R2, Mean Relative Error and Mean Absolute Error;

15. A method and apparatus for predictive modeling & analysis for knowledge discovery according to claim 1, wherein k-fold cross validation can be used to further split the learning dataset into k-folds for building models based on multiple folds that improves accuracy by reducing over-fitting. Automatically tune the algorithms kernel parameters to minimize the validation error during k-fold cross-validation of the training data thus select the best model with the highest accuracy;

16. A method and apparatus for predictive modeling & analysis for knowledge discovery according to claim 15, can be further improved wherein the number of folds in equal to the number of data-points often referred to as “Leave-One-Out cross validation”;

17. A method and apparatus for predictive modeling & analysis for knowledge discovery according to claim 1, wherein the accuracy of the models can be further improved by combining multiple weaker models to build a more accurate model using techniques called boosting and bagging;

18. A method and apparatus for predictive modeling & analysis for knowledge discovery according to claim 1, wherein a method called transductive inference can be used when testing is performed on data-points that are expected to come from a different distribution than the distribution of the data-points used in the learning dataset;

19. A method and apparatus for predictive modeling & analysis for knowledge discovery according to claim 1, wherein dominant features, with non-linear relationship, of prediction dataset with unknown ground truth can be discovered by applying Non-linear Feature Selection for Non-Support Vector algorithm;

20. A method and apparatus for predictive modeling & analysis for knowledge discovery according to claim 20, wherein Non-linear Feature Selection for Non-Support Vector algorithm can be applied to each cluster for discovering dominant features and characteristics of each cluster;
